(19) United States
(12) Patent Application Publication
(10) Pub. No.: US 2015/0217984 A1
(43) Pub. Date: Aug. 6, 2015

(54) WATER DISPENSER

(71) Applicant: Kabushiki Kaisha Cosmo Life, Kakogawa-shi, Hyogo (JP)

(72) Inventor: Yoshinori Orita, Hyogo (JP)

(73) Assignee: Kabushiki Kaisha Cosmo Life, Kakogawa-shi, Hyogo (JP)

(21) Appl. No.: 14/428,647

(22) PCT Filed: Aug. 12, 2013
(86) PCT No.: PCT/JP2013/071800

§ 371 Date: Mar. 17, 2015

(30) Foreign Application Priority Data
Sep. 18, 2012 (JP) 2012-204110

(51) Int. Cl. B67D 1/00; B67D 1/08

(52) U.S. Cl. CPC B67D 1/0004; B67D 1/0857

(57) ABSTRACT

A water dispenser includes a container receiving member movable in the horizontal direction between a received position and a pulled-out position, and a raw water supply pipe provided with a joint at the end portion of the pipe. The joint is fixed in position inside of a casing. The joint is separated from the water outlet of the raw water container when the container receiving member is in the pulled-out position, and connected to the water outlet of the raw water container when the container receiving member is in the received position.

### TECHNICAL FIELD

The present invention relates to a water dispenser in which drinking water is supplied from a replaceable raw water container filled with drinking water such as mineral water.

### BACKGROUND ART

In the past, water dispensers were used mainly in offices and hospitals, etc. However, since interest in the safety of water or in health is growing these days, the number of water dispensers used in ordinary homes is increasing. As disclosed in the below-identified patent document 1, a water dispenser is generally known in which a replaceable raw water container is placed on the top surface of a casing such that drinking water contained in the raw water container drops by gravity into a cold water tank received in the casing.

Since a replaceable raw water container is arranged on the top surface of a casing in the water dispenser disclosed in patent document 1, it is necessary to lift the raw water container filled with drinking water to a high place so as to place the container on the water dispenser. However, when the raw water container is filled with drinking water, the raw water container generally contains 10 to 12 liters of drinking water, and weighs 10 kilograms or over. Therefore, it was difficult for the user (especially, old person or woman, etc.) of the water dispenser to place such a raw water container for replacement.

In order to enable the user to easily place a raw water container for replacement, a water dispenser is proposed in the below-identified patent document 2.

This water dispenser includes a replaceable raw water container filled with drinking water, a cold water tank arranged at a higher level than the raw water container, a raw water supply pipe through which the interior of the cold water tank communicates with the interior of the raw water container, a pump attached to the raw water supply pipe, a casing in which the cold water tank and the raw water container are mounted, and a container receiving member movable in the horizontal direction, with the raw water container placed on the container receiving member, between the received position in which the raw water container is received in the casing and the pulled-out position in which the raw water container is out of the casing.

Since the raw water container is arranged at a lower level than the cold water tank in this water dispenser, it is not necessary to lift the raw water container filled with drinking water to a high place so as to place the container on the water dispenser. Also, since it is possible to pull the raw water container out of the casing together with the container receiving member, it is easy to place the raw water container for replacement.

### PRIOR ART DOCUMENT(S)

### Patent Document(s)

Patent document 1: Japanese Unexamined Patent Application Publication No. 2009-249033

Patent document 2: Japanese Patent No. 4854820

### SUMMARY OF THE INVENTION

### Problems to be Solved by the Invention

In the water dispenser disclosed in patent document 2, a raw water container is placed on a container receiving member with a water outlet of the raw water container directed downwardly, and the end portion of a raw water supply pipe through which drinking water is supplied from this raw water container is fixed to the container receiving member. In order to enable this container receiving member to be moved into and out of a casing, a stretchable spiral tube is used as the raw water supply pipe. Therefore, when the container receiving member is pulled out of the casing, the spiral tube is stretched so as to follow the movement of the container receiving member, thereby making it possible to keep the raw water container and the raw water supply pipe connected to each other.

By the way, drinking water is usually normal-temperature in a raw water supply pipe through which the interior of the raw water container communicates with the interior of a cold water tank. Therefore, when the raw water container is replaced by a brand-new raw water container, if even a small number of germs go into drinking water remaining in the raw water supply pipe, the germs may proliferate in the raw water supply pipe. In order to prevent the proliferation of germs in the raw water supply pipe, it is preferable that the total length of the raw water supply pipe is made as short as possible.

However, in the water dispenser disclosed in patent document 2, a stretchable spiral tube is used as the raw water supply pipe such that when the container receiving member is pulled out of the casing, the spiral tube can follow the movement of the container receiving member. Therefore, the total length of the raw water supply pipe is extremely long. As a result thereof, the problem exists that germs tend to proliferate in the raw water supply pipe. Instead of such a spiral tube, even if a flexible tube is used which has a slack enough to enable the flexible tube to follow the movement of the container receiving member, a similar problem still exists.

It is an object of the present invention to provide a water dispenser in which germs are less likely to proliferate in a raw water supply pipe.

### Means for Solving the Problems

The inventor of the present invention studied the reason why the total length of a raw water supply pipe of conventional water dispensers is long, and focused on the point that since the total length thereof is long, even when a container receiving member is pulled out of a casing, a raw water container and the raw water supply pipe are kept connected to each other. The inventor conceived the idea that it would be possible to shorten the total length of a raw water supply pipe, if this conventional manner were abolished and instead the raw water container were designed to be separated from the end portion of the raw water supply pipe when a container receiving member is pulled out of a casing.

In order to achieve the above object, the present invention provides a water dispenser comprising: a replaceable raw water container flexibly formed so as to shrink as the amount of water remaining in the raw water container decreases; a cold water tank arranged at a higher level than the raw water container; a raw water supply pipe through which the interior of the cold water tank communicates with the interior of the raw water container; a pump attached to the raw water supply pipe; a casing in which the cold water tank and the raw water container are mounted; and a container receiving member movable in the horizontal direction, with the raw water container placed on the container receiving member, between the received position in which the raw water container is received in the casing and the pulled-out position in which the raw water container is out of the casing, wherein the container receiving member is configured such that the raw water container is placed on the container receiving member such that a water outlet of the raw water container faces the moving direction in which the container receiving member is moved from the pulled-out position toward the received position, wherein the raw water supply pipe is provided with a joint at an end portion of the raw water supply pipe, and wherein the joint is fixed in position inside of the casing so as to be separated from the water outlet of the raw water container when the container receiving member is in the pulled-out position, and connected to the water outlet of the raw water container when the container receiving member is in the received position.

With this arrangement, when the container receiving member is pulled out of the casing, the raw water container is separated from the end portion of the raw water supply pipe, and when the container receiving member is received in the casing, the raw water container is connected to the end portion of the raw water supply pipe. Namely, the raw water supply pipe does not need to follow the movement of the container receiving member. Therefore, it is possible to shorten the raw water supply pipe, and thus to prevent the proliferation of germs in the raw water supply pipe.

If the raw water container is an entirely rigid container, when the water outlet of the rigid container is directed in the horizontal direction, it is difficult to draw up drinking water contained in the rigid container by the pump. In contrast thereto, in the water dispenser configured as described above, since the raw water container is flexibly formed so as to shrink as the amount of water remaining in the raw water container decreases, even when the raw water container is directed in the horizontal direction, it is possible to draw up drinking water contained in the raw water container by the pump.

It is preferable that the container receiving member is provided with a restricting portion configured to restrict the movement of the water outlet of the raw water container. With this arrangement, when the water outlet of the raw water container is connected to the joint, it is possible to prevent the position of the water outlet from becoming unstable due to the deformation of the flexible raw water container.

It is preferable that the raw water supply pipe includes a portion located at a lower level than the joint, and wherein the pump is attached to said portion of the raw water supply pipe. With this arrangement, when the water outlet of the raw water container is disconnected from the joint provided at the end portion of the raw water supply pipe, it is possible to prevent drinking water remaining in the raw water supply pipe from flowing out of the joint due to the remaining drinking water's own weight.

The raw water container may comprise a tubular hollow trunk portion, a bottom portion connected to the first end of the trunk portion, a shoulder portion provided at the second end of the trunk portion, a neck portion connected to the shoulder portion, a cap attached to the distal end of the neck portion, wherein the water outlet is provided in the center of the cap, and a stopper detachably fitted in the water outlet.

The joint may be a tubular member extending in the horizontal direction so as to fit in the water outlet of the raw water container, and having a water passage hole which communicates with the interior of the raw water container when the joint is fitted in the water outlet of the raw water container. At this time, it is preferable that the water passage hole is entirely formed only in the lower half of the joint. In this arrangement, since the water passage hole is formed in a relatively lower portion of the joint, even when the drinking water remaining in the raw water container decreases, it is still possible to discharge the small amount of drinking water from the raw water container such that as little drinking water as possible remains finally in the raw water container. Also, since no portion of the water passage hole is present in the upper half of the joint, when the raw water container is disconnected from the joint, it is possible to prevent air from flowing into the joint, and thus to prevent drinking water from flowing out of the joint.

The stopper may comprise a tube portion, a closed end portion formed at one end of the tube portion, and a claw portion formed along the inner periphery of the other end of the tube portion. The joint may have in the outer periphery of the joint a circumferential groove in which the claw portion of the stopper is engageable. With this arrangement, when the joint fits in the water outlet in which the stopper is fitted, the claw portion engages in the circumferential groove, thereby making it possible to hold the stopper at the distal end of the joint.

As for the distal end portion of the joint configured to be surrounded by the stopper with the claw portion engaging in the circumferential groove, it is preferable that the distal end portion is formed with a through hole extending through the distal end so as to communicate with the interior and the exterior of the joint. With this arrangement, when the stopper is fitted onto the distal end portion of the joint, the air trapped between the stopper and the distal end portion of the joint escapes into the joint through the through hole, thus making it possible to smoothly fit the stopper onto the distal end portion of the joint.

It is preferable that the diameter of the through hole formed at the distal end of the joint is 1.0 mm or less. With this arrangement, when the raw water container is disconnected from the joint, it is possible to prevent air from flowing into the joint through the through hole by the surface tension of water, and thus to prevent drinking water from flowing out of the joint through the water passage hole.

The container receiving member may comprise a bottom plate configured to support the raw water container from under the raw water container, wherein a protrusion is formed on the top surface of the bottom plate, and wherein the protrusion is configured such that when the raw water container shrinks, the protrusion tends to cause the portion of the trunk portion kept in contact with the bottom plate to be inwardly folded. With this arrangement, when the raw water container filled with drinking water is placed on the container receiving member, the portion of the trunk portion kept in contact with the bottom plate is bent by the protrusion and thus not tightened. Therefore, when drinking water is drawn up from the raw water container by the pump, the portion of the trunk portion kept in contact with the bottom plate deforms so as to be inwardly folded due to decreased pressure in the interior of the raw water container. As a result thereof, when the raw water container shrinks, a space filled with drinking water is less likely to remain in the raw water container along the bottom plate. Therefore, only a small amount of drinking water remains in the raw water container when the raw water container is replaced. For example, this protrusion may extend so as to cross the center of the trunk portion of the raw water container.

A tapered surface may be formed on a member surrounding the joint so as to guide the neck portion of the raw water container toward the joint when the raw water container is received into the casing. With this arrangement, it is possible to more reliably connect the raw water container to the joint.

### Effects of the Invention

The water dispenser according to the present invention is configured such that when the container receiving member is pulled out of the casing, the raw water container is separated from the end portion of the raw water supply pipe, and such that when the container receiving member is received in the casing, the raw water container is connected to the end portion of the raw water supply pipe. Namely, the raw water supply pipe does not need to follow the movement of the container receiving member. Therefore, it is possible to shorten the raw water supply pipe, and thus to prevent the proliferation of germs in the raw water supply pipe.

### BRIEF DESCRIPTION OF THE DRAWINGS

FIG. 1 is a sectional view of a water dispenser according to an embodiment of the present invention as seen from the lateral side.

FIG. 2 is an enlarged view illustrating the container receiving member of FIG. 1 and the vicinity of the container receiving member.

FIG. 3 is a sectional view taken along the line of FIG. 2.

FIG. 4 is a view illustrating the state in which the container receiving member illustrated in FIG. 2 is pulled out of a casing.

FIG. 5 is an enlarged sectional view illustrating the joint of FIG. 2 and the vicinity of the joint.

FIG. 6 is an enlarged sectional view illustrating the state in which a raw water container is not connected to the joint of FIG. 5 yet.

FIG. 7 is an enlarged sectional view illustrating the state in which a stopper of a water outlet of a raw water container is in contact with the joint illustrated in FIG. 6.

FIG. 8 is a view illustrating how the raw water container illustrated in FIG. 2 gradually shrinks.

FIG. 9 is a view illustrating how a raw water container gradually shrinks if a protrusion is not formed on the container receiving member illustrated in FIG. 2.

FIG. 10 is a sectional view of the water dispenser illustrated in FIG. 1, the view illustrating a sterilization operation mode.

### BEST MODE FOR CARRYING OUT THE INVENTION

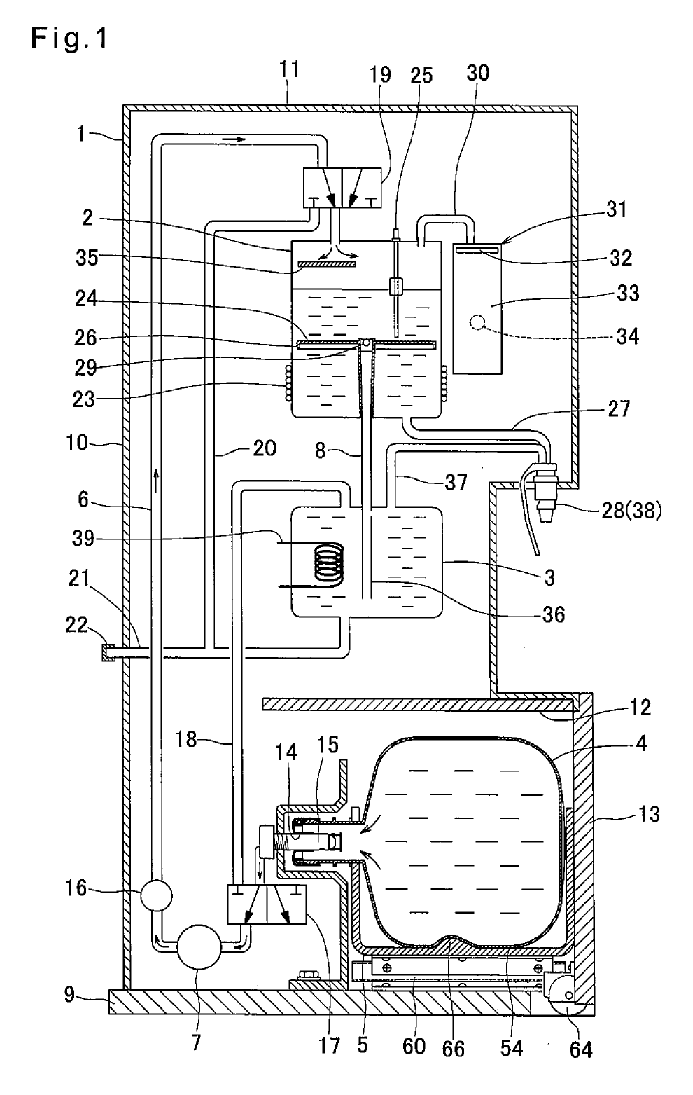

FIG. 1 illustrates a water dispenser according to the embodiment of the present invention. This water dispenser includes a casing 1 elongated in the longitudinal direction, a cold water tank 2 and a hot water tank 3 which are received in the upper portion of the casing 1, a replaceable raw water container 4 received in the lower portion of the casing 1, a container receiving member 5 on which the raw water container 4 is placed, a raw water supply pipe 6 through which the interior of the raw water container 4 communicates with the interior of the cold water tank 2, a pump 7 attached to the raw water supply pipe 6, and a tank connection line 8 through which the cold water tank 2 and the hot water tank 3 are connected together. The cold water tank 2 and the hot water tank 3 are vertically aligned with each other such that the tank 3 is located downwardly of the tank 2.

The casing 1 includes a bottom plate 9, a peripheral wall 10 extending upwardly from the periphery of the bottom plate 9, a top plate 11 attached to the top end of the peripheral wall 10. The peripheral wall 10 defines, at the front lower portion thereof, a loading space 12 into and out of which the raw water container 4 is movable. The loading space 12 is opened and closed by a front door 13 provided at the front lower portion of the peripheral wall 10.

One end of the raw water supply pipe 6 is connected to a joint 15 which can be attached to and detached from a water outlet 14 of the raw water container 4. The other end of the raw water supply pipe 6 is connected to the cold water tank 2. The raw water supply pipe 6 first extends downwardly from the joint 15 so as to pass through a position lower than the joint 15, and then changes its direction so as to extend upwardly. The pump 7 is attached to the portion of the raw water supply pipe 6 lower than the joint 15.

By the pump 7, drinking water is transferred from the raw water container 4 to the cold water tank 2 through the raw water supply pipe 6. The pump 7 may be a diaphragm pump. The diaphragm pump includes a driving device which reciprocates a diaphragm, not illustrated in the drawings, a pump chamber whose volume increases and decreases due to the reciprocation of the diaphragm, an inlet side check valve which is attached to the inlet of the pump chamber and which allows drinking water to flow only into the pump chamber, and an outlet side check valve which is attached to the outlet of the pump chamber and which allows drinking water to flow only out of the pump chamber.

A flow sensor 16 is attached to the portion of the raw water supply pipe 6 on the outlet side of the pump 7. While the pump 7 is operating, when the flow of drinking water has stopped in the raw water supply pipe 6, the flow sensor 16 can detect this state.

A first switch valve 17 is provided between the pump 7 and the joint 15 of the raw water supply pipe 6. Though the first switch valve 17 is arranged away from the joint 15 in the figures, the first switch valve 17 may be connected directly to the joint 15. A first bypass pipe 18 which communicates with the hot water tank 3 is connected to the first switch valve 17. The end portion of the first bypass pipe 18 on the side of the hot water tank 3 is connected to the top surface of the hot water tank 3.

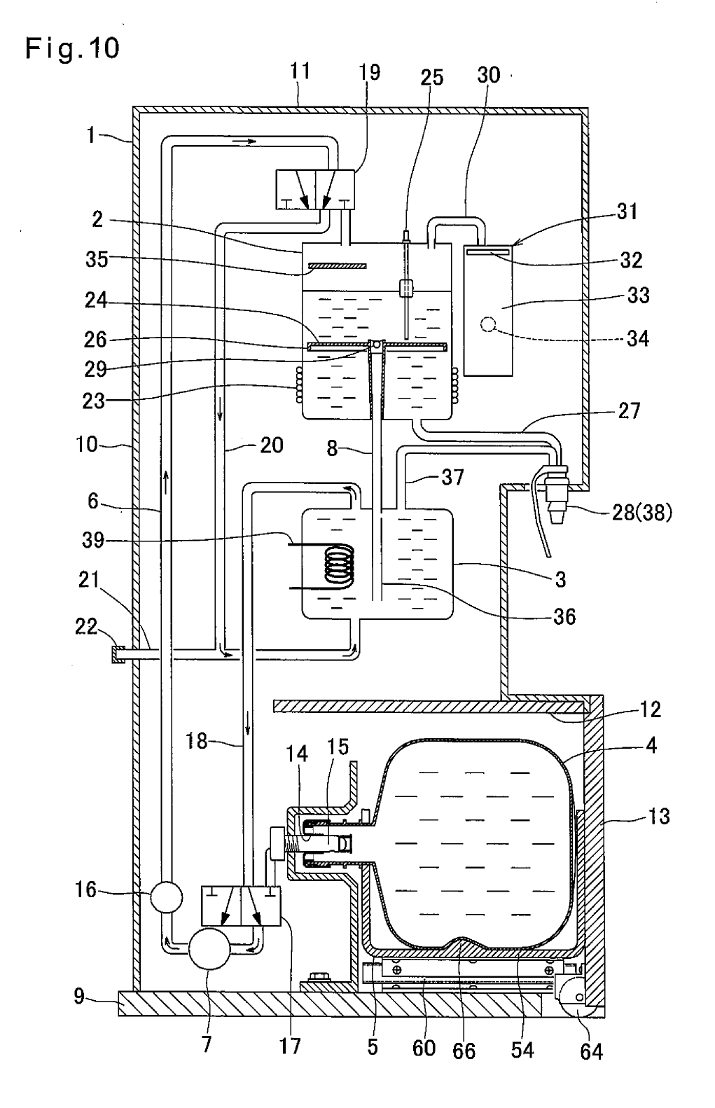

The first switch valve 17 can switch the flow of drinking water by moving between a normal operation position (see FIG. 1) in which the first switch valve 17 allows communication between the joint 15 and the pump 7, while blocking communication between the first bypass pipe 18 and the pump 7, and a sterilization operation position (see FIG. 10) in which the first switch valve 17 allows communication between the first bypass pipe 18 and the pump 7, while blocking communication between the joint 15 and the pump 7.

A second switch valve 19 for hot water sterilization is provided at the end portion of the raw water supply pipe 6 on the side of the cold water tank 2. A second bypass pipe 20 which communicates with the hot water tank 3 is connected to the second switch valve 19. The end portion of the second bypass pipe 20 on the side of the hot water tank 3 is connected to the bottom surface of the hot water tank 3. Also, a drain pipe 21 is connected to the second bypass pipe 20 so as to extend to the exterior of the casing 1. The outlet of the drain pipe 21 is closed by a plug 22. An on-off valve may be used instead of the plug 22.

The second switch valve 19 can switch the flow of drinking water by moving between a normal operation position (see FIG. 1) in which the second switch valve 19 allows communication between the raw water supply pipe 6 and the cold water tank 2, while blocking communication between the raw water supply pipe 6 and the second bypass pipe 20, and a sterilization operation position (see FIG. 10) in which the second switch valve 19 allows communication between the raw water supply pipe 6 and the second bypass pipe 20, while blocking communication between the raw water supply pipe 6 and cold water tank 2.

The first switch valve 17 and the second switch valve 19 shown are each constituted by a single three-way valve. However, instead of such valves 17 and 19, switch valve assemblies may be used each constituted by a plurality of on-off valves and having the same function as the valve 17 or the valve 19.

The cold water tank 2 contains both air and drinking water in two layers with the air forming the upper layer and the water forming the lower layer. The cold water tank 2 has a cooling device 23 attached thereto which cools drinking water received in the tank 2. Also, the cold water tank 2 is provided in the interior thereof with a baffle plate 24 which partitions the interior of the tank 2 into upper and lower portions. The cooling device 23 is arranged on the outer periphery of the lower portion of the cold water tank 2, and keeps drinking water stored lower than the baffle plate 24 of the tank 2 at a low temperature (about 5 degrees Celsius).

The cold water tank 2 has a water level sensor 25 attached thereto which detects the water level of drinking water stored in the tank 2. When the water level sensor 25 detects that the water level of drinking water has fallen, the pump 7 is activated so that drinking water is supplied from the raw water container 4 to the cold water tank 2, according to how much the water level of drinking water has fallen. When drinking water is supplied from the raw water container 4 to the cold water tank 2, the baffle plate 24 prevents low-temperature drinking water cooled by the cooling device 23 and stored in the lower portion of the tank 2 from mixing with and being stirred by normal-temperature drinking water supplied from the container 4 to the tank 2. The baffle plate 24 has a tubular hanging wall 26 extending downwardly from the outer peripheral edge of the plate 24, whereby air trapped in the space surrounded by the hanging wall increases heat-insulating effect between the upper and lower sides of the baffle plate 24.

The cold water tank 2 has a cold water discharge line 27 which is connected to the bottom surface of the tank 2 and through which low-temperature drinking water stored in the lower portion of the tank 2 is discharged outside. The cold water discharge line 27 has a cold water cock 28 mounted thereto which is operable from the outside of the casing 1. By opening this cold water cock 28, low-temperature drinking water can be discharged from the cold water tank 2 into a cup, etc. The volume of the cold water tank 2 is smaller than the volume of the raw water container 4, and is about 2 to 4 liters.

The tank connection line 8, through which the cold water tank 2 and the hot water tank 3 are connected together, has a top end opening at the top surface of the baffle plate 24 at its center. A check valve 29 is mounted in the end portion of the tank connection line 8 on the side of the cold water tank 2 so as to allow the flow of drinking water into the hot water tank 3 from the cold water tank 2, and prevent the flow of drinking water into the tank 2 from the tank 3. The check valve 29 thus prevents high-temperature drinking water stored in the hot water tank 3 from flowing into the cold water tank 2 due to heat convection, so that energy loss in the tank 2 and the tank 3 does not occur.

The hot water tank 3 is filled with drinking water. The hot water tank 3 has a heating device 39 attached thereto which heats drinking water stored in the tank 3 and keeps it at a high temperature (about 90 degrees Celsius). Though the figures illustrate a sheath heater as the heating device 39, the heating device 39 may be a band heater. The sheath heater is constituted by a pipe made of metal and a heat-generating wire which is received in the pipe and to which electric current is conducted so that heat is generated in the wire. The sheath heater is attached to the hot water tank 3 to extend through the wall of the tank 3 into the tank 3. The band heater is a cylindrical heat-generating member having a heat-generating wire embedded therein to which electric current is conducted so that heat is generated in the wire. The band heater is attached to the hot water tank 3 so as to be in close contact with the outer periphery of the tank 3.

An air sterilization chamber 31 is connected to the cold water tank 2 through an air introduction line 30. The air sterilization chamber 31 includes a hollow case 33 formed with an air intake 32, and an ozone generator 34 provided in the case 33. The ozone generator 34 may be, for example, a low-pressure mercury lamp which applies ultraviolet rays to oxygen contained in air so as to change the oxygen into ozone, or a silent discharge device which applies AC voltage between a pair of electrodes opposed to each other and covered with insulators so as to change the oxygen between the electrodes into ozone. Since electric current is conducted to the ozone generator 34 at predetermined time intervals so that ozone is generated by the ozone generator 34, there is always a certain amount of ozone in the case 33 of this air sterilization chamber 31.

Air is introduced through the air introduction line 30 into the cold water tank 2 according to how much the water level of drinking water has fallen in the tank 2 so that the interior of the tank 2 is maintained at atmospheric pressure. Also at this time, since air which has passed through the air sterilization chamber 31 and thus has been sterilized by ozone is introduced into the cold water tank 2, air is kept clean in the tank 2.

The cold water tank 2 is provided in the interior thereof with a diffusing plate 35 which diffuses the flow of drinking water supplied through the raw water supply pipe 6 to the cold water tank 2 before the supplied drinking water reaches the surface of drinking water which has been already stored in the tank 2. This diffusing plate 35 enables drinking water supplied to the cold water tank 2 to come into contact, over a large surface area, with ozone contained in air in the tank 2 (ozone which has flowed into the tank 2 from the air sterilization chamber 31), so that drinking water is kept hygienic in the tank 2.

The tank connection line 8 has an in-tank pipe 36 extending downwardly from the top surface of the hot water tank 3 in the interior of the tank 3. An open bottom end of the in-tank pipe 36 is arranged in the vicinity of the bottom surface of the hot water tank 3, thereby preventing high-temperature drinking water heated by the heating device 39 and flowing upwardly from directly flowing into the open bottom end of the in-tank pipe 36.

The hot water tank 3 has a hot water discharge line 37 which is connected to the top surface of the tank 3 and through which high-temperature drinking water stored in the upper portion of the tank 3 is discharged outside. The hot water discharge line 37 has a hot water cock 38 mounted thereto which is operable from the outside of the casing 1. By opening the hot water cock 38, high-temperature drinking water can be discharged from the hot water tank 3 into a cup, etc. When drinking water is discharged from the hot water tank 3, since drinking water equal in amount to the discharged drinking water flows through the tank connection line 8 into the hot water tank 3 from the cold water tank 2, the tank 3 is always filled with drinking water. The volume of the hot water tank 3 is about 1 to 2 liters.

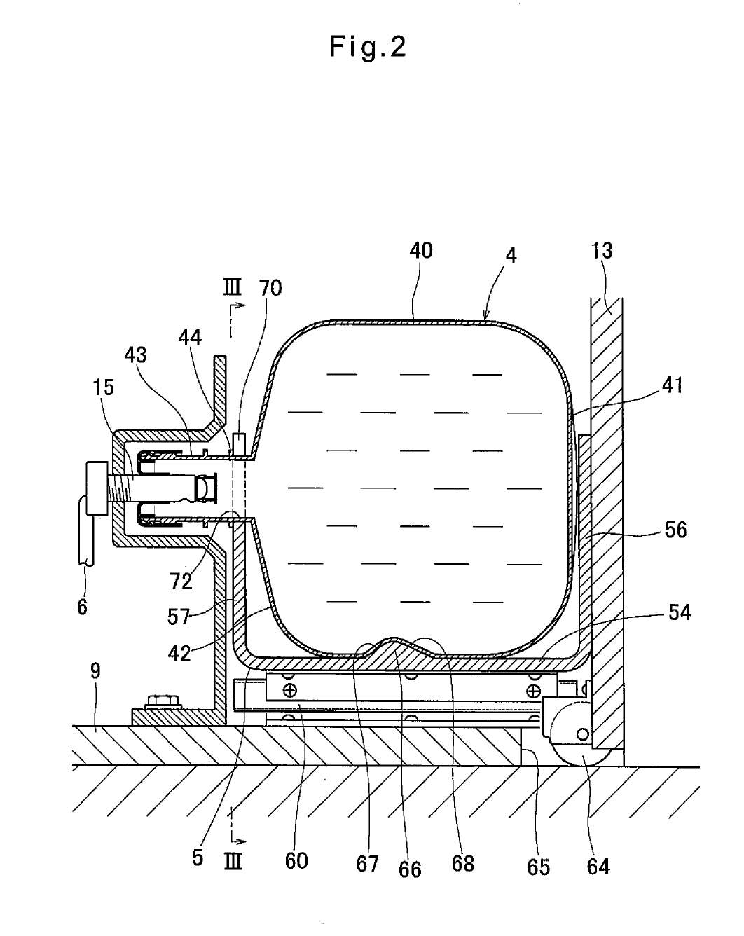

As illustrated in FIG. 2, the raw water container 4 includes a tubular hollow trunk portion 40, a bottom portion 41 connected to one end of the trunk portion 40, and a neck portion 43 connected to the other end of the trunk portion 40 through a shoulder portion 42. A flange 44 is formed on the outer periphery of the neck portion 43. The trunk portion 40 of the raw water container 4 is flexibly formed so as to shrink as the amount of water remaining in the container 4 decreases. The raw water container 4 may be formed by blow molding of, for example, polyethylene terephthalate (PET) resin or polyethylene (PE) resin. The maximum volume of the raw water container 4, i.e. the maximum amount of drinking water the container 4 can hold, is about 10 to 20 liters.

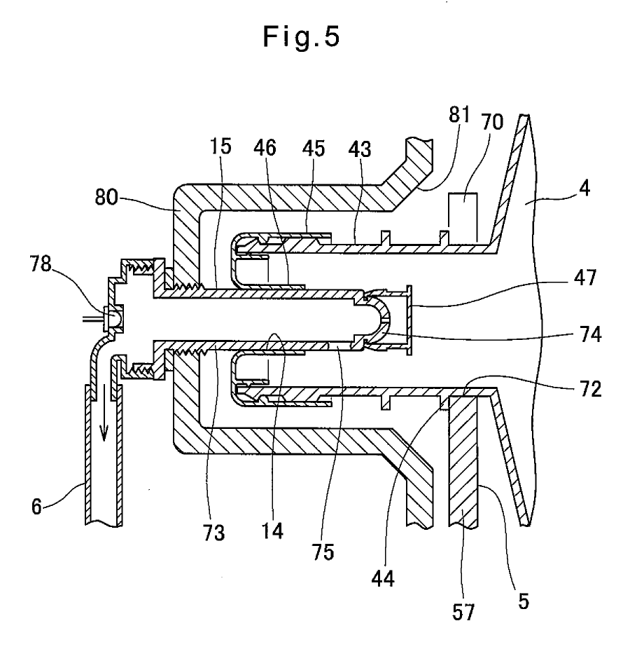

As illustrated in FIG. 5, a cap 45 is attached to the distal end of the neck portion 43 of the raw water container 4. The cap 45 is formed in the center thereof with an inner pipe 46 extending toward the interior of the raw water container 4 in parallel to the neck portion 43 and having openings at both ends thereof. The water outlet 14 is defined by the interior space of the inner pipe 46, and a stopper 47 is detachably fitted in this water outlet 14.

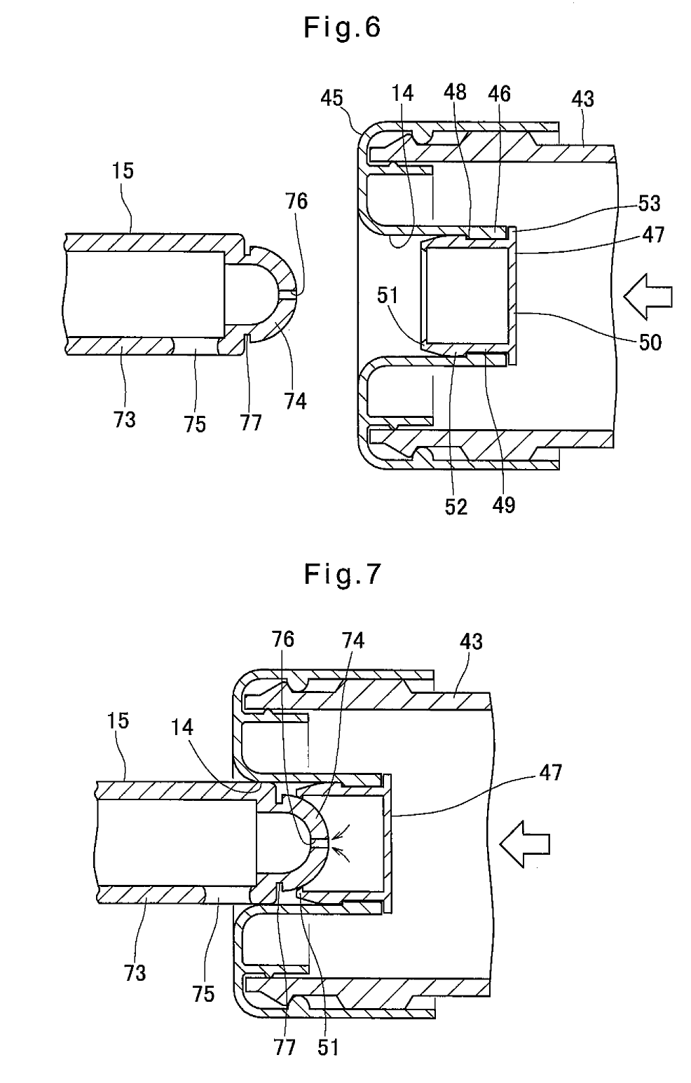

As illustrated in FIG. 6, a step 48 is formed on the inner peripheral surface of the inner pipe 46 close to the interior of the raw water container 4 such that the portion of the tube 46 formed with the step 48 has a diameter smaller than the diameter of the portion of the tube 46 not formed with the step 48. The stopper 47 is a tubular member including a tube portion 49, a closed end portion 50 formed at one end of the tube portion 49, and a claw portion 51 formed along the inner periphery of the other end of the tube portion 49. The stopper 47 is fitted in the inner pipe 46 such that the opening of the stopper 47 faces the exterior of the raw water container 4. The tube portion 49 is formed on the outer peripheral surface thereof with a protrusion 52 which engages with the step 48 of the inner pipe 46. The tube portion 49 is formed at the end portion thereof on the interior side of the raw water container 4 with an opposed piece 53 which is axially opposed to the end portion of inner pipe 46.

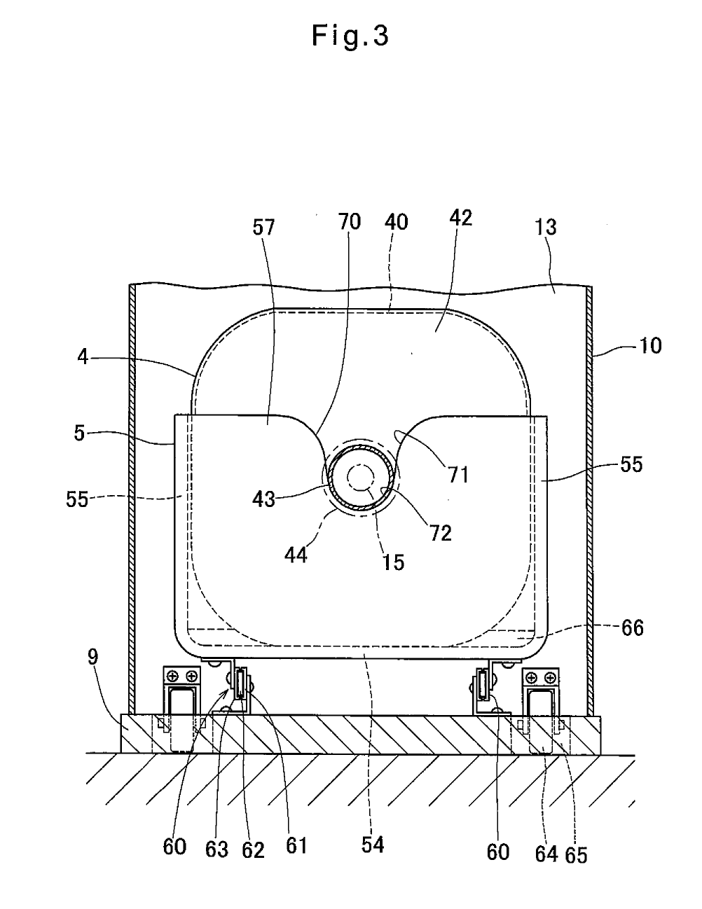

As illustrated in FIGS. 2 and 3, the container receiving member 5 includes a bottom plate 54 supporting the raw water container 4 from under the container 4, side plates 55 arranged on the right and left sides of the container 4, respectively, a front plate 56 arranged on the front side of the container 4, and a rear plate 57 arranged on the rear side of the container 4. As used herein, the word “front” refers to the side of the water dispenser on which the user usually stands to use the water dispenser, and the word “rear” refers to the opposite side of the water dispenser away from the user. The receiving member 5 is supported by a pair of right and left sliding rails 60 which extend in the front-to-rear direction.

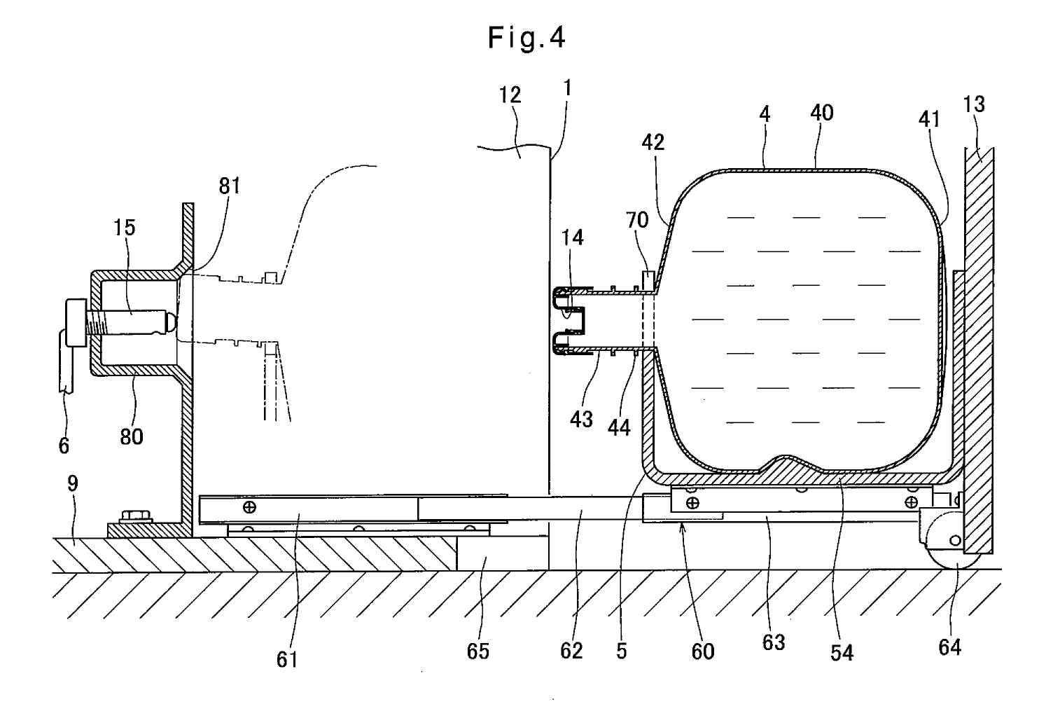

As illustrated in FIG. 4, each of the sliding rails 60 includes a fixed rail member 61 fixed to the bottom plate 9 of the casing 1 and extending in the front-to-rear direction, an intermediate rail member 62 slidably supported by the fixed rail member 61, and a movable rail member 63 slidably supported by the intermediate rail member 62. The movable rail members 63 are fixed to the bottom plate 54 of the container receiving member 5. Due to relative sliding movement of the three rail members 61, 62, 63 constituting each of the sliding rails 60, the container receiving member 5 can be moved in the horizontal direction between the received position (position illustrated in FIG. 2) in which the raw water container 4 is received in the casing 1 and the pulled-out position (position illustrated in FIG. 4) in which the container 4 is out of the casing 1.

The raw water container 4 is placed on the container receiving member 5 with the water outlet 14 of the container 4 facing the direction in which the receiving member 5 is moved from the pulled-out position toward the received position (which is the rearward direction in the embodiment). At this time, the neck portion 43 of the raw water container 4 faces a horizontal direction.

The joint 15 is fixed in position inside of the casing 1 such that, as illustrated in FIG. 4, when the container receiving member 5 is in the pulled-out position, the water outlet 14 of the raw water container 4 is separated from the joint 15, and such that, as illustrated in FIG. 2, when the container receiving member 5 is in the received position, the water outlet 14 of the raw water container 4 is connected to the joint 15.

The front door 13 of the casing 1 is fixed to the container receiving member 5 so as to be slidable together with the receiving member 5. Therefore, when the front door 13 is pulled in the forward direction, thus opening the loading space 12, the container receiving member 5 is pulled out of the casing 1 simultaneously. When the front door 13 is pushed back in the rearward direction until the loading space 12 is closed by the front door 13, the container receiving member 5 is received into the casing 1 simultaneously.

Wheels 64 are attached to the lower portion of the front door 13 so as to come into rolling contact with the surface on which the casing 1 is placed. When a load (e.g., weight of the raw water container 4 filled with drinking water or user's weight) is applied to the container receiving member 5 with the receiving member 5 pulled out of the casing 1, the wheels 64 support such a load, thereby preventing the casing 1 from toppling down. The bottom plate 9 of the casing 1 is formed with recesses 65 into which the respective wheels 64 are received.

As illustrated in FIG. 2, the bottom plate 54 of the container receiving member 5 is provided with a protrusion 66 which extends so as to cross the center of the trunk portion 40 of the raw water container 4. The protrusion 66 is formed on the top surface thereof with a slant face 67 which descends from the top of the protrusion 66 toward the first side on which the joint 15 is located, and a slant face 68 which descends from the top of the protrusion 66 toward the second side opposite from the first side. The slant face 68 descends toward the second side less steeply than the slant face 67 descends toward the first side. The slant angle of the slant face 68 is predetermined to be 30 degrees or less.

As illustrated in FIG. 3, the rear plate 57 of the container receiving member 5 is formed with a cutout 70 which opens to the upper edge of the rear plate 57. The cutout 70 comprises an introducing portion 71 which gradually narrows from the upper edge of the rear plate 57 toward the bottom of the cutout 70, and a semicircular restricting portion 72 continuous with the lower side of the introducing portion 71 and configured to fit on the outer periphery of the neck portion 43 of the raw water container 4. The restricting portion 72 is configured to fit on the portion of the neck portion 43 closer to the trunk portion 40 than is the flange 44.

The restricting portion 72 is circular arc-shaped and has a diameter smaller than the outer diameter of the flange 44 formed on the neck portion 43 of the raw water container 4. The restricting portion 72 fits on the outer periphery of the neck portion 43 such that the neck potion 43 is positioned in the radial direction, thereby preventing the water outlet 14 of the container 4 from getting out of alignment with the joint 15 when the raw water container 4 is connected to the joint 15. Also as illustrated in FIG. 2, the restricting portion 72, by engaging with the flange 44 of the neck portion 43 such that the neck portion 43 is positioned in the axial direction, restricts the movement of the raw water container 4 such that the water outlet 14 of the container 4 is not separated from the joint 15.

As illustrated in FIG. 5, the joint 15 is a horizontally extending tubular member configured to fit in the water outlet 14 of the raw water container 4. The joint 15 includes a straight portion 73 having a cylindrical surface on its outer periphery, and a distal end portion 74 having a semi-spherical shape. The straight portion 73 has such a diameter that the straight portion 73 fits in the water outlet 14 (i.e., inner pipe 46) of the raw water container 4 with an interference. The straight portion 73 is formed with a water passage hole 75 configured to communicate with the interior of the raw water container 4 with the joint 15 fitted in the water outlet 14 of the container 4. The water passage hole 75 is entirely formed only in the lower half of the joint 15, and no portion of the hole 75 is present in the upper half of the joint 15.

As illustrated in FIGS. 6 and 7, the distal end portion 74 is formed in its center with a through hole 76 extending through the joint 15 and communicating with the interior and exterior of the joint 15. The diameter of this through hole 76 is predetermined to be 1.0 mm or less. Also, at the boundary between the straight portion 73 and the distal end portion 74, the joint 15 is formed in its outer periphery with a circumferential groove 77 in which the claw portion 51 of the stopper 47 is engageable.

As illustrated in FIG. 5, an ultraviolet ray-emitting device 78 is provided at the root of the joint 15. The ultraviolet ray-emitting device 78 is configured to apply ultraviolet rays to, and thus sterilize, drinking water in the joint 15 and to the inner surface of the joint 15. The ultraviolet ray-emitting device 78 may be a UV LED or a mercury lamp.

The joint 15 is fixed to a cup member 80 provided to surround the joint 15. The cup member 80 is a tubular member having a bottom through which the joint 15 penetrates, and is open toward the raw water container 4. The cup member 80 has a tapered surface 81 formed on the open edge of the cup portion 80 such that its diameter increases toward the raw water container 4. Even if, as illustrated by the dashed line in FIG. 4, the neck portion 43 of the container 4 gets out of alignment with the joint 15 when the raw water container 4 is received into the casing 1, the tapered surface 81 guides the neck portion 43 toward the joint 15.

Though the raw water supply pipe 6 may be a silicon tube, such a silicon tube has a problem in that since oxygen can permeate through silicon, oxygen in the air that has permeated through the silicon tube could cause proliferation of germs in the pipe 6. In order to avoid this problem, the raw water supply pipe 6 may be a metal pipe (such as a stainless steel pipe or a copper pipe). By using a metal pipe as the raw water supply pipe 6, it is possible to prevent air from permeating through the wall of the raw water supply pipe 6, thus effectively preventing proliferation of germs in the pipe 6. Such a metal pipe 6 is also sufficiently heat-resistant to hot water circulated through the pipe 6. The raw water supply pipe 6 may also be a polyethylene tube or a heat-resistant, rigid polyvinyl chloride pipe. By using such a pipe or tube as the raw water supply pipe 6 too, it is possible to prevent air from permeating through the wall of the pipe 6, thereby preventing proliferation of germs in the pipe 6.

It is now described how the above water dispenser is used.

In the normal operation mode illustrated in FIG. 1, when the user of the water dispenser operates the cold water cock 28, so that low-temperature drinking water is discharged from the cold water tank 2 into a cup, etc., the water level of drinking water in the tank 2 falls. When the user operates the hot water cock 38, so that high-temperature drinking water is discharged from the hot water tank 3 into a cup, etc., since drinking water equal in amount to the discharged drinking water is introduced through the tank connection line 8 into the hot water tank 3 from the cold water tank 2, the water level in the tank 2 also falls. When the water level sensor 25 detects that the water level in the cold water tank 2 has fallen below a predetermined lower limit of water level, the pump 7 is activated to draw up drinking water from the raw water container 4 to the tank 2.

As drinking water in the cold water tank 2 or in the hot water tank 3 is discharged outside, drinking water contained in the raw water container 4 gradually decreases, so that finally the container 4 reaches the empty state. When the container 4 has reached the empty state, since no drinking water flows in the raw water supply pipe 6 even though the pump 7 is operating, the flow sensor 16 detects this state, thereby turning on a container replacement lamp (not shown) provided at the front of the casing 1 so as to inform the user that the raw water container 4 now needs to be replaced by a new one4.

When the raw water container 4 has reached the empty state, the user replaces the empty container 4 as follows: First, as illustrated in FIG. 4, the user pulls the front door 13 toward the user so that the container receiving member 5 is pulled out of the casing 1. At this time, since the empty raw water container 4 is also moved together with the container receiving member 5, the empty container 4 is separated from the joint 15, which is fixed in position inside of the casing 1. Second, the user takes the empty raw water container 4 out of the container receiving member 5. Third, the user places a brand-new raw water container 4 filled with drinking water onto the container receiving member 5 with the neck portion 43 of the brand-new container 4 directed in the lateral direction such that the neck portion 43 is fitted in the cutout 70 of the container receiving member 5. Lastly, the user pushes the front door 13 until the container receiving member 5 is received in the casing 1. At this time, since the raw water container 4 is also moved together with the container receiving member 5, the container 4 is connected to the joint 15, which is fixed in position inside of the casing 1.

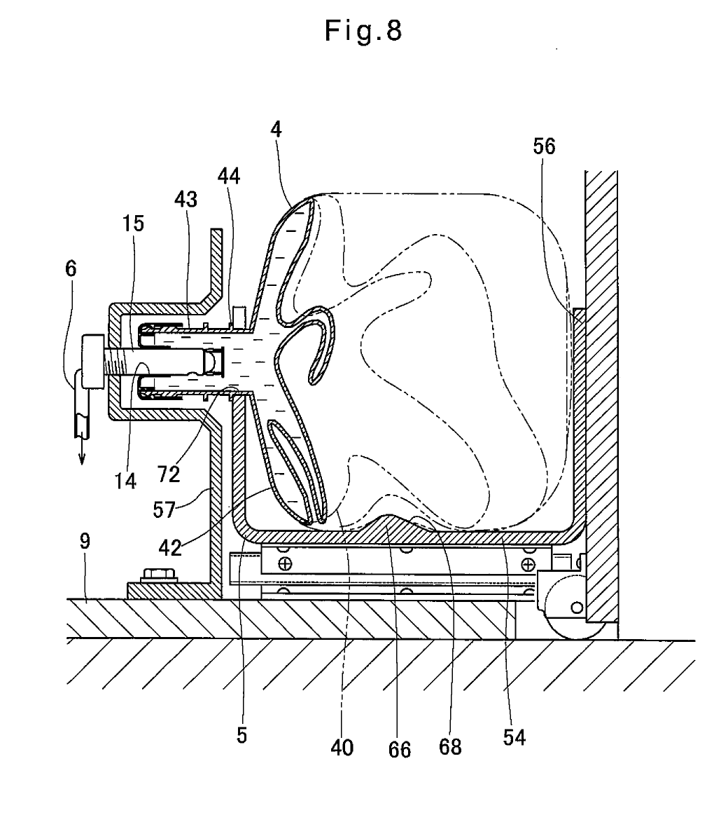

As illustrated in FIG. 8, as drinking water is drawn up from the raw water container 4 by the pump 7, the container 4 gradually shrinks under atmospheric pressure. At this time, the protrusion 66 of this water dispenser, which is provided on the bottom plate 54 of the container receiving member 5, allows the raw water container 4 to shrink in a preferable manner by making it possible to discharge drinking water from the container 4 such that as little drinking water as possible remains finally in the container 4.

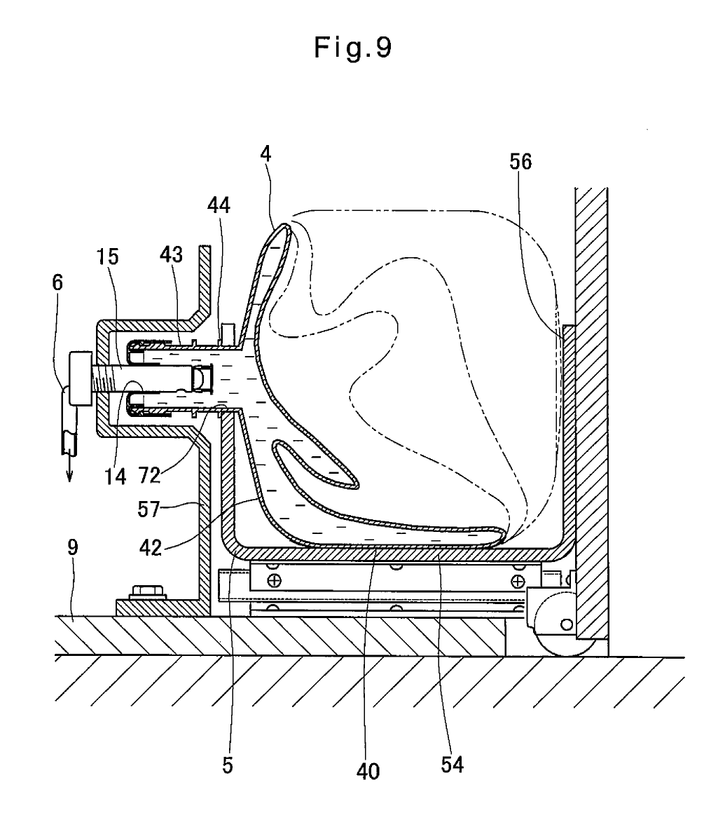

Namely, as illustrated in FIG. 9, if the bottom plate 54 of the container receiving member 5 has a flat top surface and thus the protrusion 66 is not provided on the plate 54, when the raw water container 4 filled with drinking water is placed on the container receiving member 5, the portion of the trunk portion 40 kept in contact with the plate 54 is tightened by the weight of drinking water contained in the container 4. As a result thereof, even after drinking water has been drawn up from the raw water container 4 by the pump 7, and the pressure in the interior of the container 4 has decreased, the portion of the trunk portion 40 kept in contact with the bottom plate 54 is less likely to deform. Furthermore, the shoulder portion 42 of the raw water container 4 is also less likely to deform, since the movement of the neck portion 43 is restricted by the restricting portion 72 of the rear plate 57 of the container receiving member 5. Therefore, as illustrated by the dashed lines in FIG. 9, when the raw water container 4 shrinks, the bottom portion 41 and the upper side portion of the trunk portion 40 are more likely to deform than the other portions of the raw water container 4. As a result thereof, the problem occurs that even when the raw water container 4 has shrunk to the limit, a large space filled with drinking water still remains in the container 4 along the bottom plate 54. Thus, the raw water container 4 has to be replaced with a large amount (about 400 cc to 500 cc in the worst case) of drinking water still remaining in the container 4.

In contrast thereto, as illustrated in FIG. 8, if the protrusion 66 is provided on the top surface of the bottom plate 54 of the container receiving member 5, when the raw water container 4 filled with drinking water is placed on the container receiving member 5, the portion of the trunk portion 40 kept in contact with the plate 54 is bent along the protrusion 66 and thus not tightened. Therefore, when drinking water is drawn up from the raw water container 4 by the pump 7, the portion of the trunk portion 40 kept in contact with the bottom plate 54 deforms so as to be inwardly folded due to decreased pressure in the interior of the container 4 (see the dashed lines in FIG. 8). As a result thereof, when the raw water container 4 shrinks, a space filled with drinking water is less likely to remain in the container 4 along the bottom plate 54. Therefore, only a small amount of drinking water remains in the container 4 when the container 4 is replaced.

There is the possibility that when the raw water container 4 shrinks, the deforming container 4 might get caught on the protrusion 66 so as to be prevented from shrinking. However, in the above-described embodiment, the slant face 68 of the protrusion 66 slants less steeply, thereby preventing the raw water container 4 from getting caught on the protrusion 66.

In conventional water dispensers, as the raw water supply pipe 6, a stretchable spiral tube is used such that when the container receiving member 5 is pulled out of the casing 1, the spiral tube follows the movement of the receiving member 5, or a flexible pipe is used which has a slack enough to enable the flexible pipe to follow the movement of the receiving member 5. Therefore, the total length of the raw water supply pipe 6 is extremely long, so that germs are likely to proliferate in the raw water supply pipe 6.

In contrast thereto, in the above water dispenser, when the container receiving member 5 is pulled out of the casing 1, the raw water container 4 is separated from the end of the raw water supply pipe 6, and when the receiving member 5 is received into the casing 1, the container 4 is connected to the end of the pipe 6. Namely, the raw water supply pipe 6 does not need to follow the movement of the container receiving member 5. Therefore, it is possible to shorten the raw water supply pipe 6, and thus to prevent proliferation of germs in the pipe 6.

Also, since the raw water supply pipe 6 does not need to follow the movement of the container receiving member 5, it is not necessary to use a spiral pipe or a flexible pipe as the pipe 6, so that it is possible to use a rigid pipe as the pipe 6. Therefore, it is possible to use as the water supply pipe 6 a metal pipe (such as a stainless steel pipe or a copper pipe) which has extremely excellent heat resisting property and oxygen barrier property.

Also, in the above water dispenser, sterilization operation is performed regularly so as to sterilize the raw water supply pipe 6, thereby making it possible to keep the pipe 6 hygienic for a long period of time. It is now described as to this sterilization operation.

First, as illustrated in FIG. 10, the flow of drinking water is switched by the first switch valve 17 so that drinking water can flow between the first bypass pipe 18 and the pump 7 through the valve 17, and further the flow of drinking water is switched by the second switch valve 19 so that drinking water can flow between the raw water supply pipe 6 and the second bypass pipe 20 through the valve 19. Thereafter, the pump 7 is activated. As a result thereof, high-temperature drinking water stored in the hot water tank 3 flows through the first bypass pipe 18, the first switch valve 17, the raw water supply pipe 6, the second switch valve 19, and the second bypass pipe 20, so as to finally reach the tank 3 again. Namely, high-temperature drinking water stored in the hot water tank 3 circulates through the raw water supply pipe 6. At this time, electric current is conducted to the heating device 39 of the hot water tank 3, so that the circulating drinking water can be kept at a high temperature suitable for sterilization. In this way, it is possible to sterilize by heat drinking water in the interior of the raw water supply pipe 6, the inner surface of the pipe 6, and the interior of the pump 7.

After sterilization operation has finished, the pump 7 is stopped, and as illustrated in FIG. 1, the flow of drinking water is switched by the first switch valve 17 so that drinking water can flow between the joint 15 and the pump 7 through the valve 17, and further the flow of drinking water is switched by the second switch valve 19 so that drinking water can flow between the raw water supply pipe 6 and the cold water tank 2 through the valve 19. In this way, the sterilization operation mode is switched to the normal operation mode.

After sterilization operation and before returning to the normal operation position, the pump 7 may be operated for a predetermined period of time, with the first switch valve 17 in the sterilization operation position, thereby maintaining communication between the first bypass pipe 18 and the pump 7, and the second switch valve 19 in the normal operation position, thereby blocking communication between the raw water supply pipe 6 and the cold water tank 2. By this operation, since high-temperature drinking water flows into the cold water tank 2 through the raw water supply pipe 6, it is possible to sterilize the portion of the pipe 6 located between the second switch valve 19 and the cold water tank 2. At this time, though a predetermined amount of high-temperature drinking water flows into the cold water tank 2, since the baffle plate 24 prevents drinking water in the tank 2 from being stirred, and further, heat is less likely to be conducted from the upper side of the plate 24 to the lower side of the plate 24 due to the air surrounded by the hanging walls 26 of the plate 24, it is possible to keep drinking water stored in the lower portion of the tank 2 at a low temperature.

By regularly performing the sterilization operation described above, it is possible to sterilize the raw water supply pipe 6, through which normal-temperature drinking water flows in the normal operation mode, and thus to keep the pipe 6 hygienic for a long period of time.

If the raw water container 4 is an entirely rigid container, when the water outlet 14 of the rigid container is directed in the horizontal direction, it is difficult to draw up drinking water contained in the rigid container by the pump 7. In contrast thereto, in the above water dispenser, since the raw water container 4 is flexibly formed so as to shrink as the amount of water remaining in the container 4 decreases, even when the container 4 is directed in the horizontal direction, it is possible to draw up drinking water contained in the container 4 by the pump 7.

In the above water dispenser, since the restricting portion 72 of the container receiving member 5 restricts the movement of the water outlet 14 of the raw water container 4, when the water outlet 14 of the container 4 is connected to the joint 15, it is possible to prevent the position of the water outlet 14 from becoming unstable due to the deformation of the flexible raw water container 4.

In the above water dispenser, since the raw water supply pipe 6 is provided so as to pass through a position lower than the joint 15, and further the pump 7 is arranged in a position lower than the joint 15 of the pipe 6, when the water outlet 14 of the raw water container 4 is disconnected from the joint 15, it is possible to prevent drinking water remaining in the pipe 6 from flowing out of the joint 15 due to the remaining drinking water's own weight.

In the above water dispenser, since the water passage hole 75 of the joint 15 is formed in a relatively lower portion (i.e., in the lower half) of the joint 15, even when the drinking water remaining in the raw water container 4 decreases, it is still possible to discharge the small amount of drinking water from the container 4 such that as little drinking water as possible remains finally in the container 4. Also, since no portion of the water passage hole 75 is present in the area of the upper half of the joint 15, when the raw water container 4 is disconnected from the joint 15, it is possible to prevent air from flowing into the joint 15, and thus to prevent drinking water from flowing out of the joint 15.

In the above water dispenser, since the distal end portion 74 of the joint 15 is formed with the through hole 76, when the stopper 47 is fitted onto the distal end portion 74 of the joint 15 as illustrated in FIGS. 6 and 7, air trapped between the stopper 47 and the distal end portion 74 escapes into the joint 15 through the hole 76. As a result thereof, it is possible to smoothly fit the stopper 47 onto the distal end portion 74 of the joint 15.

If the diameter of the through hole 76 is 1.0 mm or less, more preferably 0.8 mm or less, when the raw water container 4 is disconnected from the joint 15, it is possible to prevent air from flowing into the joint 15 through the through hole 76 by the surface tension of water, and thus to prevent drinking water from flowing out of the joint 15 through the water passage hole 75.

In the above water dispenser, since the member surrounding the joint 15 is formed with the tapered surface 81 which guides the neck portion 43 of the raw water container 4 toward the joint 15, it is possible to reliably connect the container 4 to the joint 15.

In the above-described embodiment, though the flange 44 is formed on the neck portion 43 of the raw water container 4, the flange 44 may be formed on the cap 45, which is attached to the neck portion 43. Also, no flange may be formed on the neck portion 43 of the raw water container 4, and instead a clamping means which carries the neck portion 43 may be mounted to the container receiving member 5 so as to restrict the movement of the water outlet 14 of the raw water container 4.

In the above-described embodiment, the water dispenser is configured such that the container receiving member 5 is moved out of and into the casing 1 in the forward and rearward directions, so that the space on which the water dispenser is placed is made small. However, the water dispenser may be configured such that the container receiving member 5 is moved out of and into the casing 1 in the rightward and leftward directions.

In the present invention, the term “horizontal” used for the horizontal movement of the container receiving member 5 does not need to be horizontal in a strict sense. For example, the term “horizontal” used therefor may mean a slant by which the pulled-out position is made slightly lower than the received position such that once the container receiving member 5 is pulled out of the casing 1, it is naturally held in the pulled-out position, or may mean a slant by which the pulled-out position is made slightly higher than the received position such that after the container receiving member 5 has been moved out of the casing 1, it spontaneously moves back into the casing 1.

The above-described embodiment illustrates as the raw water container 4 a container including the tubular hollow trunk portion 40, the bottom portion 41 connected to one end of the trunk portion 40, and the neck portion 43 connected to the other end of the trunk portion 40 through the shoulder portion 42, with the cap 45 mounted on the neck portion 43. However, the raw water container 4 may be a bag made of resin film and including a connector bonded to the film by heat sealing and having a water outlet, or may comprise such a bag and a corrugated paperboard box in which this bag is received (so-called “bag-containing box”).

### DESCRIPTION OF REFERENCE NUMERALS

1: casing
2: cold water tank
4: raw water container
5: container receiving member
6: raw water supply pipe
7: pump
14: water outlet
15: joint
40: trunk portion
41: bottom portion
42: shoulder portion
43: neck portion
45: cap
47: stopper
49: tube portion
50: closed end portion
51: claw portion
54: bottom plate
66: protrusion
72: restricting portion
75: water passage hole
74: distal end portion
76: through hole
77: circumferential groove
81: tapered surface

1. A water dispenser comprising:
a replaceable raw water container flexibly formed so as to shrink as an amount of water remaining in the raw water container decreases;
a cold water tank arranged at a higher level than the raw water container;
a raw water supply pipe through which an interior of the cold water tank communicates with an interior of the raw water container;
a pump attached to the raw water supply pipe;
a casing in which the cold water tank and the raw water container are mounted; and
a container receiving member movable in a horizontal direction, with the raw water container placed on the container receiving member, between a received position in which the raw water container is received in the casing and a pulled-out position in which the raw water container is out of the casing,
wherein the container receiving member is configured such that the raw water container is placed on the container receiving member such that a water outlet of the raw water container faces a moving direction in which the container receiving member is moved from the pulled-out position toward the received position,
wherein the raw water supply pipe is provided with a joint at an end portion of the raw water supply pipe, and
wherein the joint is fixed in position inside of the casing so as to be separated from the water outlet of the raw water container when the container receiving member is in the pulled-out position, and connected to the water outlet of the raw water container when the container receiving member is in the received position.

2. The water dispenser according to claim 1, wherein the container receiving member is provided with a restricting portion configured to restrict a movement of the water outlet of the raw water container.

3. The water dispenser according to claim 1, wherein the raw water supply pipe includes a portion located at a lower level than the joint, and wherein the pump is attached to said portion of the raw water supply pipe.

4. The water dispenser according to claim 1, wherein the raw water container comprises a tubular hollow trunk portion, a bottom portion connected to a first end of the trunk portion, a shoulder portion provided at a second end of the trunk portion, a neck portion connected to the shoulder portion, a cap attached to a distal end of the neck portion, wherein the water outlet is provided in a center of the cap, and a stopper detachably fitted in the water outlet.

5. The water dispenser according to claim 4, wherein the joint is a tubular member extending in the horizontal direction so as to fit in the water outlet of the raw water container, wherein a water passage hole is entirely formed only in a lower half of the joint, so as to communicate with an interior of the raw water container when the joint is fitted in the water outlet of the raw water container.

6. The water dispenser according to claim 5, wherein the stopper comprises a tube portion, a closed end portion formed at one end of the tube portion, and a claw portion formed along an inner periphery of another end of the tube portion,
wherein the joint has in an outer periphery of the joint a circumferential groove in which the claw portion of the stopper is engageable,
wherein the joint has a distal end portion configured to be surrounded by the stopper with the claw portion engaging in the circumferential groove, and
wherein the distal end portion is formed with a through hole extending through the distal end portion so as to communicate with an interior and an exterior of the joint.

7. The water dispenser according to claim 6, wherein a diameter of the through hole is 1.0 mm or less.

8. The water dispenser according to claim 4, wherein the container receiving member comprises a bottom plate configured to support the raw water container from under the raw water container, wherein a protrusion is formed on a top surface of the bottom plate, and wherein the protrusion is configured such that when the raw water container shrinks, the protrusion tends to cause a portion of the trunk portion kept in contact with the bottom plate to be inwardly folded.

9. The water dispenser according to claim 8, wherein the protrusion extends so as to cross a center of the trunk portion of the raw water container.

10. The water dispenser according to claim 4, wherein a tapered surface is formed on a member surrounding the joint so as to guide the neck portion of the raw water container toward the joint when the raw water container is received into the casing.

11. The water dispenser according to claim 1, wherein the raw water container comprises a tubular hollow trunk portion, a bottom portion connected to a first end of the trunk portion, a shoulder portion provided at a second end of the trunk portion, a neck portion connected to the shoulder portion, a cap attached to a distal end of the neck portion, wherein the water outlet is provided in a center of the cap, and a stopper detachably fitted in the water outlet, and wherein the container receiving member is provided with a restricting portion configured to restrict a movement of the water outlet of the raw water container.
